(19) United States
(12) Patent Application Publication
(10) Pub. No.: US 2014/0339954 A1
(43) Pub. Date: Nov. 20, 2014

(54) VIBRATION POWER GENERATOR

(71) Applicant: PANASONIC CORPORATION, Osaka (JP)

(72) Inventors: Takehiko YAMAKAWA, Osaka (JP); Yasuyuki NAITO, Osaka (JP); Keiji ONISHI, Osaka (JP)

(73) Assignee: PANASONIC CORPORATION, Osaka (JP)

(21) Appl. No.: 14/275,769

(22) Filed: May 12, 2014

(30) Foreign Application Priority Data
May 17, 2013 (JP) 2013-105025

(51) Int. Cl. H02N 1/08

(52) U.S. Cl. CPC H02N 1/08
USPC 310/300

(57) ABSTRACT

A vibration power generator includes: a fixed substrate; a first fixed electrode piece disposed on the fixed substrate, the first fixed electrode piece having a first width of 2w; a second fixed electrode piece disposed on the fixed substrate, the second fixed electrode piece having a second width of 2w; a cover substrate disposed with a space g from the fixed substrate, the cover substrate being opposed to the fixed substrate; a vibrating body disposed between the fixed substrate and the cover substrate; and an electret electrode piece disposed on a side opposed to the first fixed electrode piece and the second fixed electrode piece of the vibrating body, the electret electrode piece having a width that is greater than 2w and less than or equal to 2w+s.

### BACKGROUND OF THE INVENTION

1. Field of the Invention

The present disclosure relates to a vibration power generator that converts vibration energy into electric power.

2. Description of the Related Art

In recent years, attention has been given to energy harvesting for a low-power electronic device, which is to extract electric power from energy widely present in an environment. Typical examples of the energy harvesting include solar power generation, thermoelectric power generation, and electromagnetic induction power generation in which a magnet and a coil are relatively moved by natural forces. In addition, an example of the energy harvesting includes an electrostatic-induction-type vibration power generator that extracts electric power from vibration energy of a human body, a vehicle, or a machine and the like. In the electrostatic-induction-type vibration power generator, a film called an electret including a semi-permanent charge is disposed either on an electrode formed in a vibrating body or on a fixed electrode opposed to the electrode. A capacitance between the electrodes is changed by the vibration of the vibrating body, and an inductive charge is changed. Therefore, a current and a voltage applied to a load are generated, thereby generating power.

FIG. 14 illustrates a conventional vibration power generator 1000. FIG. 14(a) is a sectional view illustrating a vibrating body 1307 in a resting state, and FIG. 14(b) is a sectional view illustrating a state in which the vibrating body 1307 is maximally displaced. As illustrated in FIG. 14, an insulating film 1302 is disposed on a fixed substrate 1301. A plurality of first fixed electrode pieces 1303 each having a width of 2w and a plurality of second fixed electrode pieces 1304 each having a width of 2w are alternately disposed on the insulating film 1302 with spaces s therebetween. A spacer 1305 is disposed on the fixed substrate 1301. The spacer 1305 and the vibrating body 1307 are connected to each other by at least two springs 1306. The vibrating body 1307 is disposed above the first fixed electrode piece 1303 and second fixed electrode piece 1304 on the fixed substrate 1301 with a gap g.

A plurality of electret electrode pieces 1309 are disposed on the vibrating body 1307 with an insulating film 1308 interposed therebetween. Each of the electret electrode piece 1309 is injected with negative charge and has a width (a length in an X-direction in FIG. 14) of 2w. When the vibrating body 1307 is in the resting state, the electret electrode piece 1309 is disposed so as to be opposed to the second fixed electrode piece 1304. A cover substrate 1310 is disposed above the vibrating body 1307. The cover substrate 1310 is disposed so as to be in contact with an upper surface of the spacer 1305. With this configuration, the vibrating body 1307 is sealed by the fixed substrate 1301, the spacer 1305, and the cover substrate 1310.

The vibrating body 1307 is configured to be slidable in an X-direction and a −X-direction. As illustrated in FIG. 14, a positive inductive charge is maximally induced in the first fixed electrode piece 1303 at a maximum point of a changing ratio of a capacitance between the electret electrode piece 1309 and the first fixed electrode piece 1303. A positive inductive charge is maximally induced in the second fixed electrode piece 1304 at the maximum point of a changing ratio of a capacitance between the electret electrode piece 1309 and the second fixed electrode piece 1304. An inductive current is excited by an increase or decrease of the charge. The inductive current generates a voltage applied to a load 1311, and the vibration power generator generates power (see NPTL 1).

FIG. 15 illustrates time waveforms of a displacement 1401 of the vibrating body 1307 and an AC voltage 1402 between the first fixed electrode piece 1303 and the second fixed electrode piece 1304 when the vibrating body 1307 is displaced with a sine wave. The electret electrode piece 1309 intersects the plurality of second fixed electrode pieces 1304 while the vibrating body 1307 is displaced for one cycle of the sine-wave displacement 1401 by the spring vibration. Accordingly, a frequency of the AC voltage 1402 is higher than that of the displacement 1401 of the vibrating body 1307. FIG. 16 illustrates time waveforms of a displacement 1501 of the vibrating body 1307 and a voltage 1502 between the first fixed electrode piece 1303 and the second fixed electrode piece 1304 when large acceleration is provided to the vibrating body 1307 in a short period of time. The displacement 1501 indicates a vibration having the large amplitude in a first half and a free damping vibration having a damping constant of the spring 1306 in a second half. The voltage 1502 indicates the AC voltage that is generated between the first fixed electrode piece 1303 and the second fixed electrode piece 1304 by the change in capacitance between the electret electrode piece 1309 and each of the first fixed electrode piece 1303 and the second fixed electrode piece 1304.

### CITATION LIST

### Non-Patent Literature

NPTL 1: Yuji Suzuki, “A MEMS electret generator with electrostatic levitation for vibration-driven energy-harvesting applications”, Journal of Micromechanics and Microengineering, Volume 20, Issue 10 (October 2010)

### SUMMARY OF THE INVENTION

One non-limiting and exemplary embodiment provides a vibration power generator that can extract an output of a power generator with a proper load even if an amplitude of a vibrating substrate is changed by the acceleration provided from the outside or a free damping vibration. Additional benefits and advantages of the disclosed embodiments will be apparent from the specification and drawings. The benefits and/or advantages may be individually provided by the various embodiments and features of the specification and drawings of the present disclosure, and need not all be provided in order to obtain one or more of the same.

In accordance with one aspect of the present disclosure, a vibration power generator includes: a fixed substrate; a first fixed electrode piece that is disposed on the fixed substrate, the first fixed electrode piece having a width of 2w; a second fixed electrode piece that is disposed on the fixed substrate with a space s from the first fixed electrode piece, the second fixed electrode piece having a width of 2w; a cover substrate that is disposed with a space from the fixed substrate, the cover substrate being opposed to the fixed substrate; a vibrating body that is disposed between the fixed substrate and the cover substrate in a vibratable state; and an electret electrode piece that is provided on the vibrating body on a side opposed to the first fixed electrode piece and the second fixed electrode piece, the electret electrode piece having a width that is greater than 2w and less than or equal to 2w+s. In the vibration power generator, the electret electrode piece is opposed to both the first fixed electrode piece and the second fixed electrode piece while extending over the first fixed electrode piece and the second fixed electrode piece, when the vibrating body is in a resting state.

According to the present disclosure, the vibration power generator can obtain the high power generation efficiency.

### BRIEF DESCRIPTION OF DRAWINGS

FIG. 1 is a sectional view illustrating a vibration power generator 100 according to a first exemplary embodiment of the present disclosure, FIG. 1(a) is a sectional view illustrating a state in which a vibrating body 107 is in a resting state, and FIG. 1(b) is a sectional view illustrating a state in which the vibrating body 107 is maximally displaced;

FIG. 2 is a partially enlarged section of the vibration power generator 100, FIG. 2(a) is a partially enlarged section illustrating the vibration power generator 100 when the vibrating body 107 is in the resting state, and FIG. 2(b) is a partially enlarged section illustrating the state in which the vibrating body 107 is maximally displaced;

FIG. 3 is a graph illustrating changes of a displacement 301 and an AC voltage 302 to time with respect to a sine-wave vibration of the vibrating body 107 in the vibration power generator 100;

FIG. 4 is a graph illustrating time changes of a displacement 401 and an AC voltage 402 with respect to a free vibration when the vibrating body 107 of the vibration power generator 100 performs a free damping vibration displacement;

FIG. 5 illustrates a vibration power generator 100A according to a modification of the first exemplary embodiment of the present disclosure, FIG. 5(a) is a sectional view illustrating the state in which the vibrating body 107 is in the resting state, and FIG. 5(b) is a sectional view illustrating the state in which the vibrating body 107 is maximally displaced;

FIG. 6 illustrates a partially enlarged section of the vibration power generator 100A, FIG. 6(a) is a partially enlarged section illustrating the vibration power generator 100A when the vibrating body 107 is in the resting state, and FIG. 6(b) is a partially enlarged section illustrating the state in which the vibrating body 107 is maximally displaced;

FIG. 7 is a sectional view illustrating a vibration power generator 200 according to a second exemplary embodiment of the present disclosure, FIG. 7(a) is a sectional view illustrating the state in which the vibrating body 107 is in the resting state, and FIG. 7(b) is a sectional view illustrating the state in which the vibrating body 107 is maximally displaced;

FIG. 8 is a partially enlarged section of the vibration power generator 200, FIG. 8(a) is a partially enlarged section illustrating the vibration power generator 200 when the vibrating body 107 is in the resting state, and FIG. 8(b) is a partially enlarged section illustrating the state in which the vibrating body 107 is maximally displaced;

FIG. 9 is a graph illustrating a change in AC voltage 802 to a displacement 801 with respect to a sine-wave vibration of the vibrating body 107 of the vibration power generator 200 according to the second exemplary embodiment of the present disclosure;

FIG. 10 is a graph illustrating time changes of a displacement 901 and an AC voltage 902 with respect to the free vibration when the vibrating body 107 of the vibration power generator 200 performs the free damping vibration displacement;

FIG. 11 is a plan view illustrating a configuration example of a first fixed electrode piece 103 and a second fixed electrode piece 104;

FIG. 12(a) is a plan view illustrating a configuration example of an electret electrode piece 109, and FIG. 12(b) is a plan view illustrating another configuration example of the electret electrode piece 109;

FIG. 13 is a perspective view illustrating an example in which a spacer 105, the vibrating body 107, and a spring 106 are integrally constructed;

FIG. 14 illustrates a conventional vibration power generator 1000, FIG. 14(a) is a sectional view illustrating a vibrating body 1307 in a resting state, and FIG. 14(b) is a sectional view illustrating a state in which the vibrating body 1307 is maximally displaced;

FIG. 15 illustrates time waveforms of a displacement 1401 of the vibrating body 1307 and an AC voltage 1402 between a first fixed electrode piece 1303 and a second fixed electrode piece 1304 when a vibrating body 1307 is displaced with a sine wave; and

FIG. 16 illustrates time waveforms of a displacement 1501 of the vibrating body 1307 and a voltage 1502 between the first fixed electrode piece 1303 and the second fixed electrode piece 1304 when large acceleration is provided to the vibrating body 1307 in a short period of time.

### DETAILED DESCRIPTION OF THE PREFERRED EMBODIMENTS

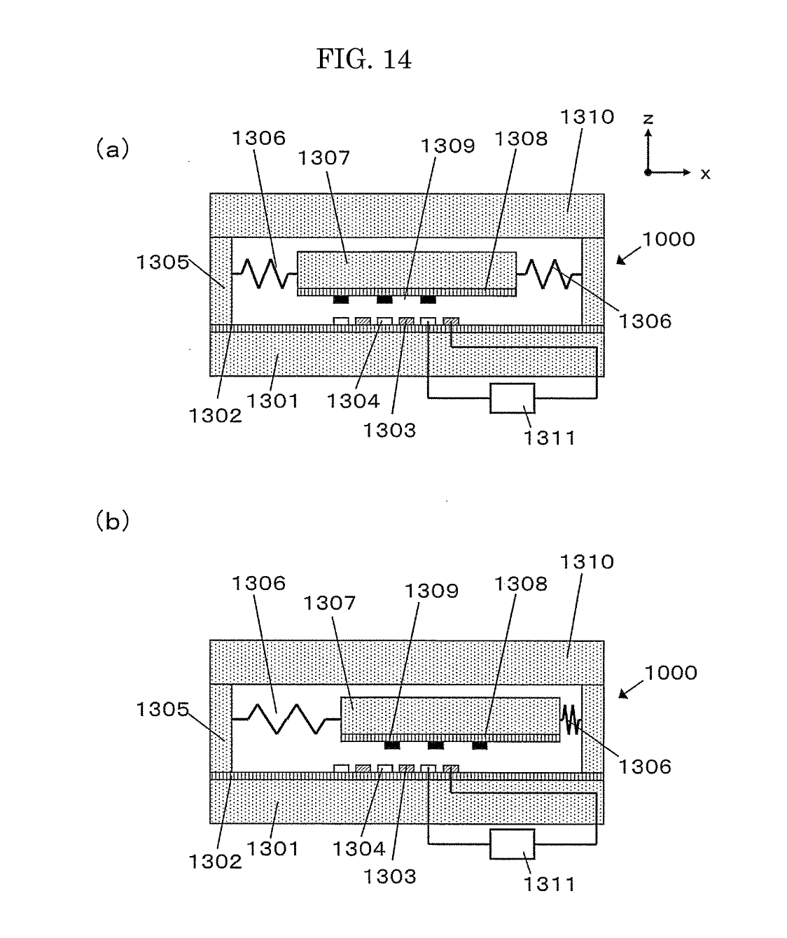

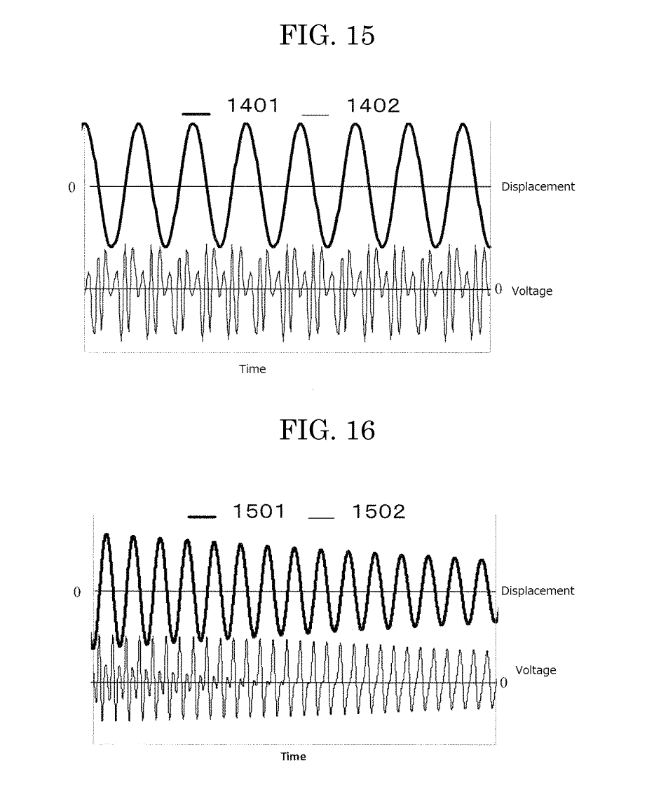

(Underlying Knowledge Forming Basis of the Present Disclosure) In the conventional vibration power generator 1000 having the configuration in FIG. 14, the AC voltage 1402 between the first fixed electrode piece 1303 and the second fixed electrode piece 1304 changes depending on a number of first fixed electrode pieces 1303 (or one second fixed electrode piece 1304) intersected by one electret electrode piece 1309 (opposed to one electret electrode piece 1309 during one cycle of a vibration). In the case that the displacement 1401 has a large amplitude, the electret electrode piece 1309 intersects more first fixed electrode pieces 1303 to enhance a frequency of AC voltage 1402. On the other hand, in the case that the displacement 1401 has the small amplitude, the electret electrode piece 1309 intersects less first fixed electrode pieces 1303 to lower the frequency of the AC voltage 1402.

An optimum load on a power generator is generally expressed by ½πfC, where C is a capacitance of the power generator and f is the frequency of the AC voltage 1402. Accordingly, the optimum load changes when the frequency f of the AC voltage 1402 changes. In the case that the amplitude of the displacement 1401 changes, sometimes an output of the power generator is extracted with a load different from the optimum load, which results in a problem in that power generation efficiency goes down. That is to say, in the conventional vibration power generator, the amplitude of the vibrating substrate is changed by an influence of the acceleration provided from an outside, and it is difficult to efficiently extract an output of the power generator.

The AC voltage 1402 having the substantially equal amplitude is obtained when the capacitance between the electret electrode piece 1309 and the second fixed electrode piece 1304 becomes the maximum or minimum at the maximum or minimum point of the displacement 1401. However, in the case that the capacitance becomes maximum or minimum when the displacement 1401 is not maximized or minimized because of the change in amplitude of the displacement 1401, the output of the AC voltage 1402 becomes small at the maximum point of the displacement 1401, and the large voltage and the small voltage are outputted in a mixed form, which results in a problem in that the power generation efficiency goes down.

Additionally, the numbers of first fixed electrode pieces 1303 and second fixed electrode pieces 1304, which intersect the electret electrode piece 1309, decrease in the case that the amplitude of the displacement 1501 decreases from a large value to a small value because of the free damping vibration. For this reason, the frequency of the AC voltage 1402 changes. In this case, the optimum load is changed in the same, which results in a problem in that extracting the output of the power generator with the optimum load becomes difficult.

As a result of earnest study for solving the problems, the inventors of the present disclosure found the vibration power generator that can extract the output of the power generator with the proper load even if the maximum amplitude is changed. Specifically, in the resting state of the vibrating body, the electret electrode piece is overlapped with at least one of the first fixed electrode piece and the second fixed electrode piece. On the other hand, in the vibration state of the vibrating body, a range where the vibrating body can be vibrated is regulated such that the electret electrode piece is not overlapped with the first fixed electrode piece or the second fixed electrode piece except the first fixed electrode piece or the second fixed electrode piece, on which the electret electrode piece is overlapped in the resting state. According to the present disclosure, even if the amplitude of the vibrating substrate is changed by the acceleration provided from the outside or the free damping vibration, a frequency of an output voltage is kept constant, and the output of the power generator can be extracted with the proper load. As a result, the vibration power generator can obtain the high power generation efficiency.

Hereinafter, the present disclosure will be described in detail with reference to the drawings. In the following description, a term (such as “up”, “down”, “right”, “left”, and another term including these terms) indicating a specific direction or position is used. However, the use of the terms is aimed at easy understanding of the disclosure with reference to the drawings, and it is noted that the technical scope of the present disclosure is not restricted by the meaning of the term. In the following drawings, the same component is designated by the same numeral.

### First Exemplary Embodiment

A vibration power generator according to a first exemplary embodiment includes: a fixed substrate; a first fixed electrode piece that is disposed on the fixed substrate, the first fixed electrode piece having a first width of 2w; a second fixed electrode piece that is disposed on the fixed substrate with a space s from the first fixed electrode piece, the second fixed electrode piece having a second width of 2w; a cover substrate that is disposed with a space g from the fixed substrate, the cover substrate being opposed to the fixed substrate; a vibrating body that is disposed between the fixed substrate and the cover substrate in a vibratable state; and an electret electrode piece that is disposed on the vibrating body, the electret electrode piece being on a side opposed to the first fixed electrode piece and the second fixed electrode piece, the electret electrode piece having a width that is greater than 2w and less than or equal to 2w+s. In the vibration power generator, the electret electrode piece is opposed to both the first fixed electrode piece and the second fixed electrode piece and overlaps with both the first fixed electrode piece and the second fixed electrode piece, when the vibrating body is in a resting state. Hereinafter, exemplary embodiments of the present disclosure will be described with reference to the drawings. However, the exemplary embodiments are described only by way of example, and it is noted that the technical scope of the present disclosure is not restricted to the detailed placement and dimension of each element.

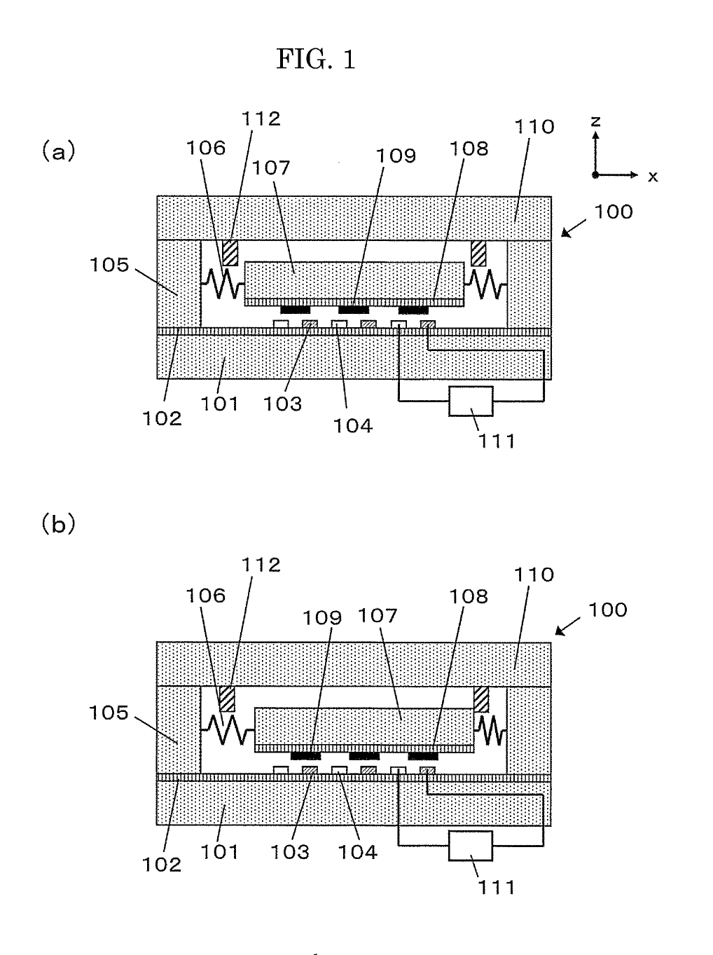

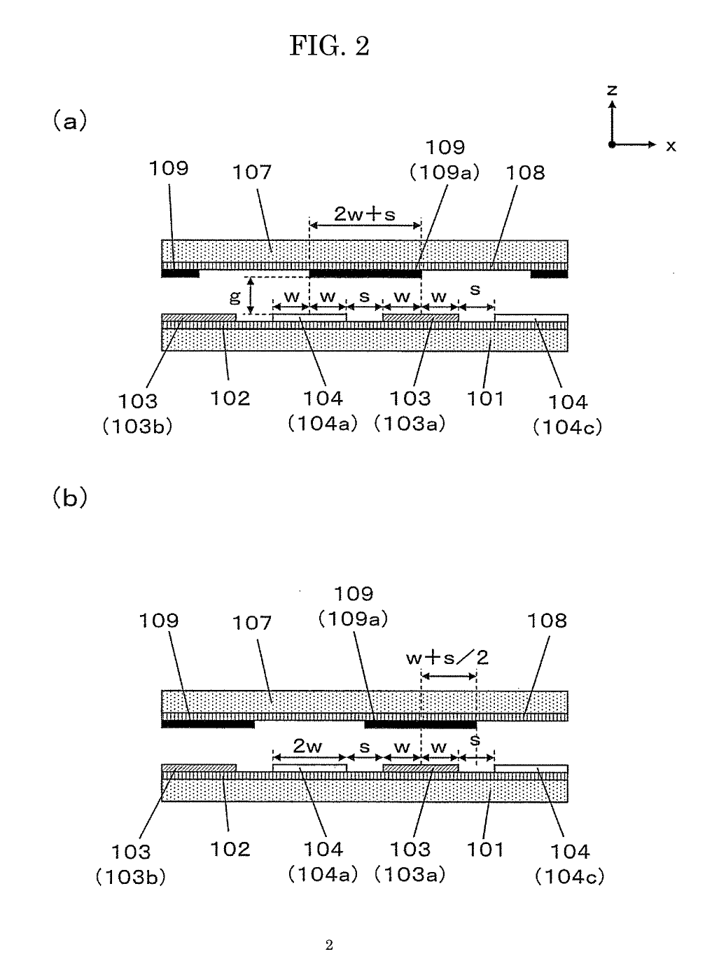

FIG. 1 illustrates a vibration power generator 100 of the first exemplary embodiment of the present disclosure. FIG. 1(a) is a sectional view illustrating a state in which a vibrating body 107 is in a resting state, and FIG. 1(b) is a sectional view illustrating a state in which the vibrating body 107 is maximally displaced. FIG. 2 is a partially enlarged section of the vibration power generator 100, FIG. 2(a) is a partially enlarged section illustrating the vibration power generator 100 when the vibrating body 107 is in the resting state, and FIG. 2(b) is a partially enlarged section illustrating the state in which the vibrating body 107 is maximally displaced. As used herein, the drawings, such as FIGS. 1(a) and 1(b), which are identical to each other in a figure number while being different from each other in an alphabet in parenthesis, are collectively called only the figure number like “FIG. 1”.

As illustrated in FIG. 1, the vibration power generator 100 includes a fixed substrate 101 made of silicon or glass and an insulating film 102 made of an oxide film disposed on the fixed substrate 101. A plurality of first fixed electrode pieces 103 and a plurality of second fixed electrode pieces 104 are alternately disposed on the insulating film 102. For example, the first fixed electrode piece 103 and the second fixed electrode piece 104 are made of polysilicon or a metallic film. As illustrated in FIG. 2, the first fixed electrode piece 103 having a first width of 2w (w×2) and the second fixed electrode piece 104 having a second width of 2w may be disposed with a space s therebetween.

A spacer 105 that extends upward (a Z-direction in FIG. 1) from the insulating film 102 is disposed on the insulating film 102. For example, the spacer 105 is made of silicon, glass, or metal. The vibrating body (vibrating substrate) 107 made of such a material as silicon or glass is disposed between the spacers 105. For example, the vibrating body 107 is supported by at least two springs (elastic members) 106 connected to both ends thereof. The vibrating body 107 is disposed above the fixed substrate 101 so as to be separated from the fixed substrate 101 (including the first fixed electrode piece 103 and the second fixed electrode piece 104). The vibrating body 107 can be vibrated in at least one direction (an X-direction in the first exemplary embodiment in FIG. 1) by the springs 106. As used herein, the term “the vibrating body is in the resting state” means a state, in which the external force (including a force of the spring 106) does not act on the vibrating body and the vibrating body is stopped. A cover substrate 110 made of a material such as silicon or glass may be disposed on the spacer 105. The vibrating body 107 can be sealed by the cover substrate 110, the spacer 105, and the fixed substrate 101 in an airtight manner or a low vacuum manner.

In the vibrating body 107, an insulating film 108 corresponding to the insulating film 102 is disposed on a surface (a lower surface of the vibrating body 107 in FIG. 1) opposed to the fixed substrate 101. On the insulating film 108, a plurality of electret electrode pieces 109 holding negative charges are disposed in a width direction. For example, a width (a length in the X-direction) of the electret electrode piece 109 is greater than or equal to the width of 2w of the first fixed electrode piece 103 or the second fixed electrode piece 104. In this case, the electret electrode piece 109 can be overlapped with the whole width of the first fixed electrode piece 103 or the second fixed electrode piece 104 during the vibration. As used herein, the term “overlap” means that overlapping is occurs when the vibrating body is viewed from above in a perpendicular direction (the Z-direction in the drawings).

For example, the width of the electret electrode piece 109 is greater than 2W and less than or equal to 2w+s (2w+s in the first exemplary embodiment in FIG. 2). In the case that the width of the electret electrode piece 109 is greater than 2w, as illustrated in FIG. 2(b), the electret electrode piece 109 is overlapped with the whole width of the first fixed electrode piece 103 or the second fixed electrode piece 104 during the vibration. Additionally, he electret electrode piece 109 is overlapped with an outside (an area where there is no first fixed electrode piece 103 or second fixed electrode piece 104) in the width direction. Therefore, the electric charge can be charged sufficiently even at an end in the width direction of the first fixed electrode piece 103 or the second fixed electrode piece 104. In the case that the width of the electret electrode piece 109 is less than or equal to 2w+s, as illustrated in FIG. 2(b), the electret electrode piece 109 is overlapped with the whole width of the first fixed electrode piece 103 or the second fixed electrode piece 104 and the outside in the width direction, and the electret electrode piece 109 can be restrained from being overlapped with on another first fixed electrode piece 103 or another second fixed electrode piece 104. The electret electrode piece 109 is disposed above the first fixed electrode piece 103 and the second fixed electrode piece 104 with a distance (gap) of g. For example, the first fixed electrode piece 103 and the second fixed electrode piece 104 are made of an oxide film or a nitride film.

The electret electrode piece 109 is opposed to (overlapped with) the first fixed electrode piece 103 and the second fixed electrode piece 104 when the vibrating body 107 is in the resting state (a displacement of the vibration is zero). In the first exemplary embodiment in FIGS. 1(a) and 2(a), the electret electrode piece 109 is disposed so as to be opposed to (overlapped with) the first fixed electrode piece 103 and the second fixed electrode piece 104 by the length of w in the width direction (X-direction).

A stopper 112 regulates the maximum amplitude (maximum displacement amount) of the vibrating body 107 such that the electret electrode piece 109 is not overlapped with the first fixed electrode piece 103 or the second fixed electrode piece 104 except the first fixed electrode piece 103 and the second fixed electrode piece 104, on which the electret electrode piece 109 is overlapped in the resting state, during the vibration of the vibrating body 107. That is, the stopper 112 comes into contact with the vibrating body 107 to regulate the maximum displacement amount of the vibrating body 107. As used herein, in the displacement, the resting state of the vibrating body 107 is set to zero, the X-direction in the drawings is set to the positive displacement, the −X-direction is set to the negative displacement, and the “displacement amount” means an absolute value of the displacement. For example, the stopper 112 regulates the maximum amplitude of the vibrating body 107 such that the electret electrode piece 109 is overlapped with only one of the first fixed electrode piece 103 and the second fixed electrode piece 104, on which the electret electrode piece 109 is overlapped in the resting state, during the vibration of the vibrating body 107. For example, the stopper 112 regulates the maximum amplitude of the vibrating body 107 such that the electret electrode piece 109 is overlapped with the whole in the width direction of one of the first fixed electrode piece 103 and the second fixed electrode piece 104, on which the electret electrode piece 109 is overlapped in the resting state, during the vibration of the vibrating body 107. For example, the stopper 112 regulates the maximum amplitude of the vibrating body 107 such that the electret electrode piece 109 is overlapped with the outside in the width direction of one of the first fixed electrode piece 103 and the second fixed electrode piece 104 in addition to the whole in the width direction of one of the first fixed electrode piece 103 and the second fixed electrode piece 104, on which the electret electrode piece 109 is overlapped in the resting state, during the vibration of the vibrating body 107.

The maximum displacement of the vibrating body 107 will be described by taking one electret electrode piece 109a in FIG. 2 as an example. As illustrated in FIG. 2(a), in the resting state of the vibrating body 107, the electret electrode piece 109a is overlapped with the first fixed electrode piece 103a and the second fixed electrode piece 104a. FIG. 2(b) illustrates the case that the vibrating body 107 in FIG. 1 is maximally displaced with the displacement of w+s/2 (the displacement becomes the maximum).

Assuming that L is a displacement from the position where the vibrating body 107 is in the resting state, the electret electrode piece 109a is overlapped with both the first fixed electrode piece 103a and the second fixed electrode piece 104a in a range of −w≦L≦w. Accordingly, in the case that an maximum displacement LM is less than or equal to w (LM≦w), the electret electrode piece 109a remains overlapped with both the first fixed electrode piece 103a and the second fixed electrode piece 104a during the vibration of the vibrating body 107.

In the case that the displacement L is equal to w (L=w), the position in the width direction (X-direction) at a right end of the electret electrode piece 109a is matched with the position at an outside end (the right end in FIG. 2) of the first fixed electrode piece 103a. In other words, the first fixed electrode piece 103a is overlapped with the whole length in the width direction of the electret electrode piece 109a. In the case that the displacement L is equal to −w (L=−w), the position in the width direction (X-direction) at a left end of the electret electrode piece 109a is matched with the position at an outside end (the left end in FIG. 2) of the second fixed electrode piece 104a. In other words, the second fixed electrode piece 104a is overlapped with the whole length in the width direction of the electret electrode piece 109a. Accordingly, in the case that the maximum displacement LM is greater than or equal to w (LM≧w), the electret electrode piece 109a can be overlapped with the whole length in the width direction of one of the first fixed electrode piece 103a and the second fixed electrode piece 104a during the vibration of the vibrating body 107.

In the case that the displacement L is greater than w (L>w), the position in the width direction (X-direction) at the right end of the electret electrode piece 109a is located outside the position at the outside end (the right end in FIG. 2) of the first fixed electrode piece 103a. In other words, the electret electrode piece 109a is overlapped with the outside of the first fixed electrode piece 103a in addition to the whole length in the width direction of the first fixed electrode piece 103a (see FIG. 2(b)). In the case that the displacement L is less than −w (L<−w), the position in the width direction (X-direction) at the left end of the electret electrode piece 109a is located outside the position at the outside end (the left end in FIG. 2) of the second fixed electrode piece 104a. In other words, the electret electrode piece 109a is overlapped with the outside of the second fixed electrode piece 104a in addition to the whole length in the width direction of the second fixed electrode piece 104a. Accordingly, in the case that the maximum displacement LM is greater than w (LM>w), the electret electrode piece 109a can be overlapped with the outside of one of the first fixed electrode piece 103a and the second fixed electrode piece 104a in addition to the whole length in the width direction of one of the first fixed electrode piece 103a and the second fixed electrode piece 104a during the vibration of the vibrating body 107. In this case, the maximum displacement of the vibrating body 107 is regulated such that the electret electrode piece 109a is not overlapped with a second fixed electrode piece 104c. Therefore, for example, as illustrated in FIG. 2(b), the position in the width direction at the outside end (the end in the displacement direction, the right end in FIG. 2(b)) of the electret electrode piece 109a is located between the first fixed electrode piece 103a on which the electret electrode piece 109a is overlapped and the second fixed electrode piece 104c when the displacement of the vibrating body 107 becomes the maximum.

An example of the maximum displacement LM greater than w (LM>w) will be described below. The example is the case that the maximum displacement is equal to w+s/2 (LM=w+s/2) as illustrated in FIG. 2(b). The position in the width direction at the outside end of the electret electrode piece 109a is located in the center (the case in FIG. 2(b)) between the first fixed electrode piece 103a and the second fixed electrode piece 104c or is located in the center between the second fixed electrode piece 104a and the first fixed electrode piece 103b when the vibrating body 107 is maximally displaced (L=w+s/2 or L=−(w+s/2)). Therefore, the positive charge can be induced in the whole length including the neighborhood of the outside end with respect to one of the first fixed electrode piece 103a and the second fixed electrode piece 104a, on which the electret electrode piece 109a is overlapped, and the electret electrode piece 109 can be restrained from inducing the positive charge in the adjacent first fixed electrode piece 103b or the adjacent second fixed electrode piece 104c. For example, a distance s between the first fixed electrode piece 103 and the second fixed electrode piece 104 ranges from w/10 to w (w/10≦s≦w).

A power generation mechanism of the vibration power generator 100 will be described below by taking the maximum displacement of w+s/2 as an example. In the case that the vibrating body 107 has the displacement of w+s/2, as illustrated in FIG. 2(b), the electret electrode piece 109a and the first fixed electrode piece 103 are opposed to each other, and the whole of the first fixed electrode piece 103 is overlapped with the electret electrode piece 109a (a overlapping area becomes the maximum). The electret electrode piece 109a extends to the outside (the outsides in the X-direction and the −X-direction) of the first fixed electrode piece 103. In this case, the capacitance generated between the electret electrode piece 109a and the first fixed electrode piece 103 becomes the maximum to induce the most positive inductive charges in the first fixed electrode piece 103. For the displacement of w+s/2, as illustrated in FIG. 2(b), because the second fixed electrode piece 104 is not overlapped with the electret electrode piece 109a (the overlapping area becomes zero), the capacitance generated between the electret electrode piece 109a and the second fixed electrode piece 104 becomes the minimum to minimize the positive inductive charge in the second fixed electrode piece 104.

On the other hand, in the case that the vibrating body 107 has the displacement of −(w+s/2), the electret electrode piece 109 and the second fixed electrode piece 104 are opposed to each other, and the whole of the second fixed electrode piece 104 is overlapped with the electret electrode piece 109 (the overlapping area becomes the maximum) when viewed in the Z-direction. The electret electrode piece 109 extends to the outside (the outsides in the X-direction and the −X-direction) of the second fixed electrode piece 104. In this case, the capacitance generated between the electret electrode piece 109 and the second fixed electrode piece 104 becomes the maximum to induce the most positive inductive charges in the second fixed electrode piece 104. For the displacement of −(w+s/2), because the first fixed electrode piece 103 is not overlapped with the electret electrode piece 109 (the overlapping area becomes zero), the capacitance generated between the electret electrode piece 109 and the first fixed electrode piece 103 becomes the minimum to minimize the positive inductive charge in the first fixed electrode piece 103.

An inductive current is excited by increases or decreases in charges of the first fixed electrode piece 103 and the second fixed electrode piece 104, and a voltage applied to a load 111 disposed between the first fixed electrode piece 103 and the second fixed electrode piece 104 changes, whereby the vibration power generator 100 generates power. an AC voltage generated by the vibration power generator 100 is converted into a DC voltage using a rectifying circuit (not illustrated), the DC voltage is converted into a desired voltage using a regulator (not illustrated), and the voltage may be stored in a capacitor or a battery or be directly used as a power supply for a circuit included in the load 111. One of the first fixed electrode piece 103 and the second fixed electrode piece 104 may be grounded.

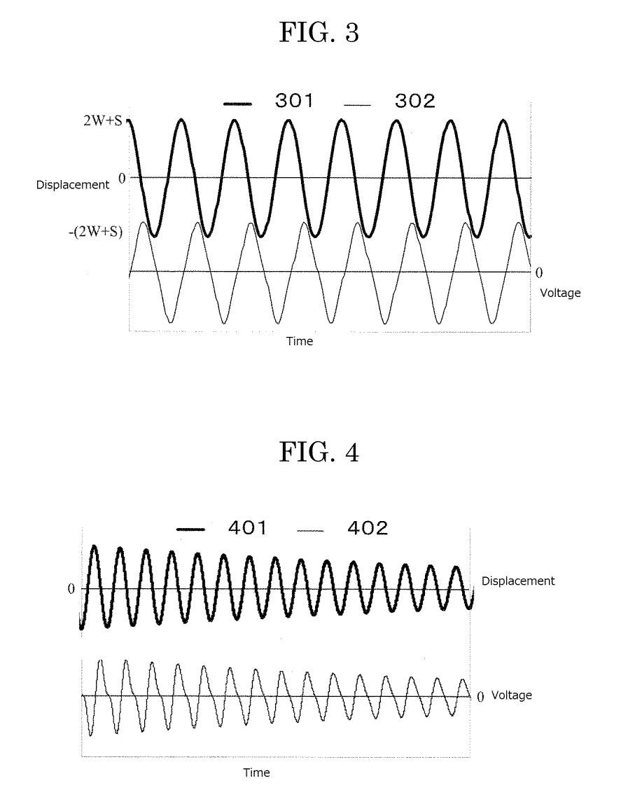

FIG. 3 is a graph illustrating changes of a displacement 301 and an AC voltage 302 to time with respect to a sine-wave vibration of the vibrating body 107 in the vibration power generator 100. The displacement 301 of the sine-wave vibration indicates that the vibrating body 107 vibrates with the amplitude of w+s/2 in the X-direction in FIG. 1 at an eigenfrequency determined by a weight of the vibrating body 107 and characteristics such as a spring constant of the spring 106. With the displacement 301 of the sine-wave vibration of the vibrating body 107, the AC voltage 302 indicates the voltage (AC voltage) generated between the first fixed electrode piece 103 and the second fixed electrode piece 104 due to the change in capacitance between the electret electrode piece 109 and the first fixed electrode piece 103 and the change in capacitance between the electret electrode piece 109 and the second fixed electrode piece 104.

As illustrated in FIG. 3, during the one cycle in which the displacement 301 of the vibrating body 107 reaches the positive maximum displacement of w+s/2 from zero, returns to zero, reaches the negative maximum displacement of −(w+s/2), and returns to zero, the AC voltage 302 reaches the positive maximum value from zero, returns to zero, reaches the negative minimum value, and returns to zero. As illustrated in FIG. 3, the displacement 301 and the AC voltage 302 differ from each other in a peak position, and a phase difference occurs between the displacement 301 and the AC voltage 302. Sometimes the phase difference occurs between the displacement 301 and the AC voltage 302 according to a condition of the load 111 connected to the vibration power generator 100.

As can be seen from the above description, the maximum amplitude (maximum displacement) of the vibrating body 107 is regulated during the vibration such that the electret electrode piece 109 is not overlapped with the first fixed electrode piece 103 and the second fixed electrode piece 104, on which the electret electrode piece 109 is not overlapped in the resting state of the vibrating body 107, whereby the vibration frequency of the displacement is always equal to the output frequency of the AC voltage. Therefore, the optimum load on the vibration power generator 100 is kept constant, and extraction efficiency of the power generator can be enhanced by setting the load 111 corresponding to the optimum load.

That is, even if the amplitude of the sine-wave vibration displacement of the vibrating body 107 vibrated by the external force does not reach the maximum displacement of w+s/2 regulated by the stopper 112, the change in capacitance generated between the electret electrode piece 109 and each of the first fixed electrode piece 103 and the second fixed electrode piece 104, and the AC voltage 302 become the positive maximum from zero, return to zero, and become the negative minimum according to the one cycle of the amplitude. At this time, the change in capacitance and the AC voltage show the waveform changes similar to those in FIG. 3.

FIG. 4 is a graph illustrating time changes of a displacement 401 and an AC voltage 402 with respect to a free vibration when the vibrating body 107 of the vibration power generator 100 performs a free damping vibration displacement. When large acceleration (external force) is applied to the vibrating body 107 from the outside, the vibrating body 107 is displaced to the maximum displacement regulated by the stopper 112, and then performs the free damping vibration displacement around the displacement of zero as in the displacement 401 according to a damping characteristic determined by the eigenfrequency of the vibrating body 107, a damping constant of the spring 106, and an electrostatic force between the electret electrode piece 109 and each of the first fixed electrode piece 103 and the second fixed electrode piece 104. At the maximum point of the displacement 401, the capacitance generated between the electret electrode piece 109 and the first fixed electrode piece 103 becomes maximum, and the capacitance generated between the electret electrode piece 109 and the second fixed electrode piece 104 becomes minimum. On the other hand, at the minimum point of the displacement 401, the capacitance generated between the electret electrode piece 109 and the second fixed electrode piece 104 becomes maximum, and the capacitance generated between the electret electrode piece 109 and the first fixed electrode piece 103 becomes minimum. The inductive current is excited by the increases or decreases in capacitances (and charges) of the first fixed electrode piece 103 and the second fixed electrode piece 104, and the voltage applied to the load 111 disposed between the first fixed electrode piece 103 and the second fixed electrode piece 104 varies, whereby the vibration power generator 100 generates power.

As can be seen from FIG. 4, even if the vibrating body 107 performs the free damping vibration, the time of the one cycle in which the vibrating body 107 is maximally displaced from the displacement of zero, returns to the displacement of zero, is minimally displaced, and returns to the displacement of zero is equal to the time of the one cycle in which the AC voltage 402 becomes minimum from zero, returns to zero, becomes maximum, and returns to zero. That is, the maximum amplitude (maximum displacement) is regulated during the vibration such that the electret electrode piece 109 is not overlapped with the first fixed electrode piece 103 and the second fixed electrode piece 104, on which the electret electrode piece 109 is overlapped in the resting state of the vibrating body 107, whereby the vibration frequency of the displacement is always equal to the output frequency of the AC voltage. Therefore, the optimum load on the vibration power generator 100 is kept constant, and the extraction efficiency of the power generator can always be enhanced by setting the load 111 corresponding to the optimum load.

### Modification

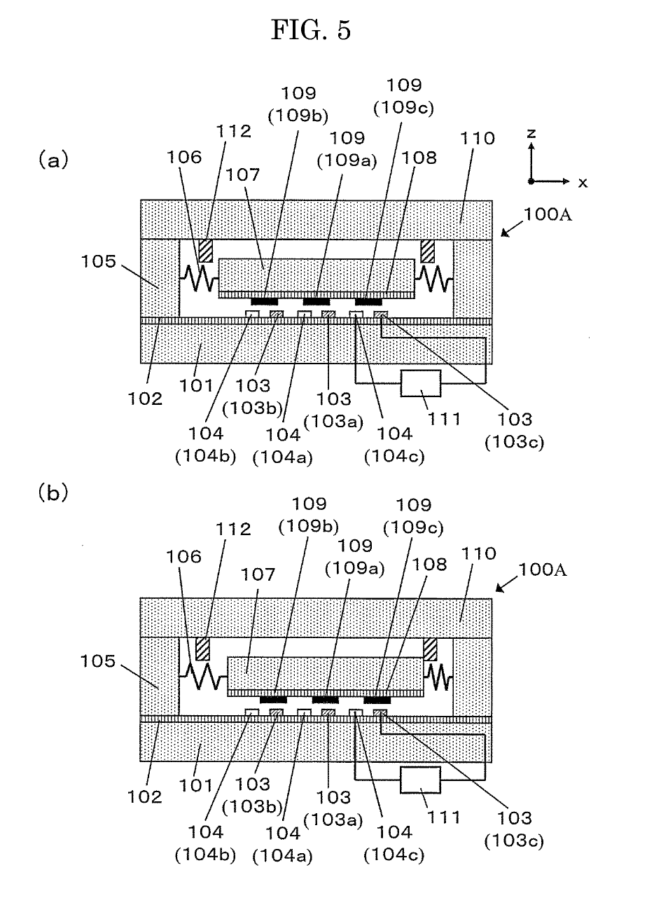

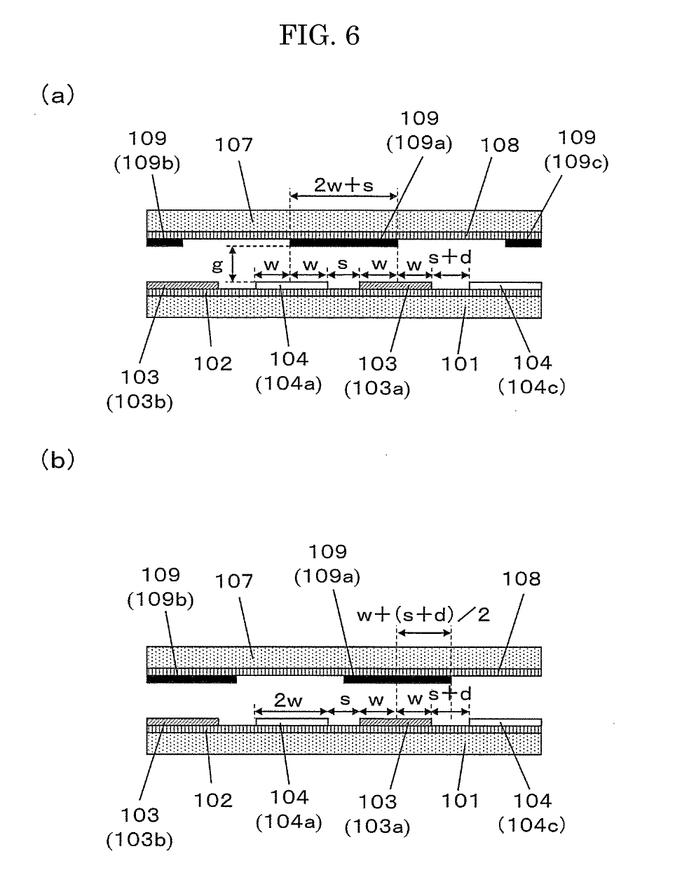

FIG. 5 illustrates a vibration power generator 100A according to a modification of the first exemplary embodiment, FIG. 5(a) is a sectional view illustrating the state in which the vibrating body 107 is in the resting state, and FIG. 5(b) is a sectional view illustrating the state in which the vibrating body 107 is maximally displaced. FIG. 6 illustrates a partially enlarged section of the vibration power generator 100A, FIG. 6(a) is a partially enlarged section illustrating the vibration power generator 100A when the vibrating body 107 is in the resting state, and FIG. 6(b) is a partially enlarged section illustrating the state in which the vibrating body 107 is maximally displaced.

The vibration power generator 100A is identical to the vibration power generator 100 in the space s between the first fixed electrode piece 103 and the second fixed electrode piece 104, on which the same electret electrode piece 109 is overlapped in the resting state of the vibrating body 107, and the vibration power generator 100A differs from the vibration power generator 100 in the space s+d (d>0) between the first fixed electrode piece 103 and the second fixed electrode piece 104, on which other electret electrode pieces 109 are overlapped in the resting state of the vibrating body 107. In the modification of the first exemplary embodiment in FIGS. 5(a) and 6(b), because the same electret electrode piece 109a is overlapped with the first fixed electrode piece 103a and the second fixed electrode piece 104a, the space between the first fixed electrode piece 103a and the second fixed electrode piece 104a is set to s. Similarly, the space between the first fixed electrode piece 103b and the second fixed electrode piece 104b is set to s, and the space between the first fixed electrode piece 103c and the second fixed electrode piece 104c is set to s.

On the other hand, the space between the first fixed electrode piece 103a and the second fixed electrode piece 104c is set to s+d, because the electret electrode piece 109a and the electret electrode piece 109c are overlapped with the first fixed electrode piece 103a and the second fixed electrode piece 104c in the resting state of the vibrating body 107, respectively. Similarly, the space between the first fixed electrode piece 103b and the second fixed electrode piece 104a is set to s+d.

For example, the stopper 112 is disposed such that the maximum displacement LM of the vibrating body 107 ranges from w+s/2 to w+s/2+d (w+s/2≦LM≦w+s/2+d). For example, the stopper 112 is disposed such that the maximum displacement LM becomes w+(s+d)/2. Therefore, when attention is focused on one electret electrode piece 109 (for example, electret electrode piece 109a), a distance increases from the first fixed electrode piece 103 or the second fixed electrode piece 104 (for example, first fixed electrode piece 103b and the second fixed electrode piece 104c), on which the electret electrode piece 109 is not overlapped in the resting state or the vibration state of the vibrating body 107. Therefore, the electret electrode piece 109, which is not overlapped with the first fixed electrode piece 103 or the second fixed electrode piece 104 even if the vibrating body 107 vibrates to the maximum displacement LM, can be restrained from generating the inductive charge in the first fixed electrode piece 103 or the second fixed electrode piece 104.

Any positive value may be used as the value of d. For example, s/4≦d≦3s/4. For example, d=s/2. Each element of the vibration power generator 100A may have the same configuration as the corresponding element of the vibration power generator 100 unless otherwise noted.

In the vibration power generators 100 and 100A of the first exemplary embodiment, as described above, a closed space can be formed in the airtight manner by the fixed substrate 101, the spacer 105, and the cover substrate 110 such that external air is not mixed. Therefore, charge stripping from the electret electrode piece 109 can securely be restrained. The configuration of the sealing structure is not limited to the first exemplary embodiment, but the sealing structure may be fabricated by any configuration.

Although the spring 106 has a form of a coil spring in the first exemplary embodiment in FIGS. 1 and 5, the spring 106 is not limited to the coil spring. Any form such as a plate-like high-resilience material may be used as long as the spring 106 performs spring operation.

The materials for the fixed substrate 101, the insulating film 102, the first fixed electrode piece 103, the second fixed electrode piece 104, the spacer 105, the vibrating body 107, the insulating film 108, the electret electrode piece 109, and the cover substrate 110 are described above by way of example and the present disclosure is not limited thereto. Alternatively, the fixed substrate 101 and the cover substrate 110 may be made of a resin substrate or a metallic block. The first fixed electrode piece 103 and the second fixed electrode piece 104 may be made of conductive materials such as aluminum and copper. The electret electrode piece 109 may be made of an organic electret material.

In the first exemplary embodiment in FIGS. 1 and 5, the electret electrode piece 109 is located above the first fixed electrode piece 103 and the second fixed electrode piece 104 but the present disclosure is not limited thereto. In the vibration power generator of the present disclosure, it is only necessary to dispose the electret electrode piece 109 such that the electret electrode piece 109 is opposed to the first fixed electrode piece 103 and the second fixed electrode piece 104. For example, the electret electrode piece 109 may be located below the first fixed electrode piece 103 and the second fixed electrode piece 104. Alternatively, the first fixed electrode piece 103 and the second fixed electrode piece 104 may sequentially be disposed in the perpendicular direction, and the plurality of electret electrode pieces 109 corresponding to the first fixed electrode piece 103 and the second fixed electrode piece 104 may be disposed in the perpendicular direction. The first fixed electrode piece 103 and the second fixed electrode piece 104 may be disposed in the vibrating body 107, and electret electrode piece 109 may be disposed in the fixed substrate 101.

A lead wire to the load 111 is illustrated by hard wiring in FIGS. 1 and 5. Alternatively, a wiring electrode on the substrate or a substrate-through electrode may be disposed. In the first exemplary embodiment, the negative charge is injected in the electret electrode piece 109. Alternatively, the positive charge may be injected. In the case that the positive charge is injected in the electret electrode piece 109, the inductive charges induced in the first fixed electrode piece 103 and the second fixed electrode piece 104 have negative polarities, and the current direction is inverted. However, the same effect as the first exemplary embodiment is obtained.

### Second Exemplary Embodiment

A vibration power generator according to a second exemplary embodiment includes: a fixed substrate; a first fixed electrode piece that is disposed on the fixed substrate, the first fixed electrode piece having a first width of 2w; a second fixed electrode piece that is disposed on the fixed substrate with a space s from the first fixed electrode piece, the second fixed electrode piece having the second width of 2w; a cover substrate that is disposed with a space g from the fixed substrate, the cover substrate being opposed to the fixed substrate; a vibrating body that is disposed between the fixed substrate and the cover substrate in a vibratable state; and an electret electrode piece that is disposed on the vibrating body, the electret electrode piece being opposed to the first fixed electrode piece and the second fixed electrode piece, the electret electrode piece having a width that is greater than or equal to 2w. In the vibration power generator, the electret electrode piece is opposed to the whole width of one of the first fixed electrode piece and the second fixed electrode piece, when the vibrating body is in a resting state. The second exemplary embodiment will be described in detail below.

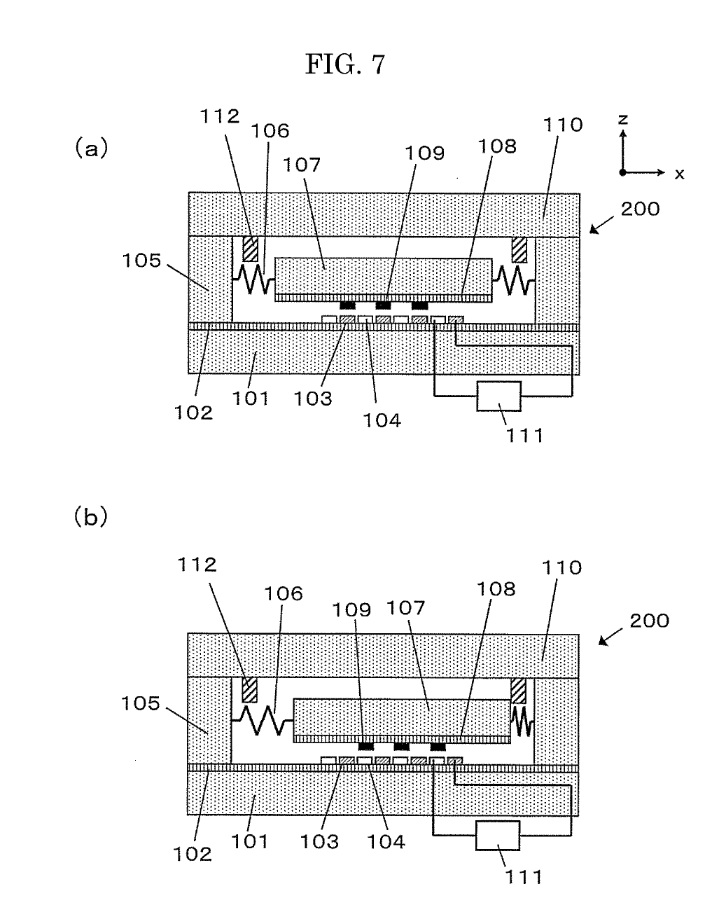

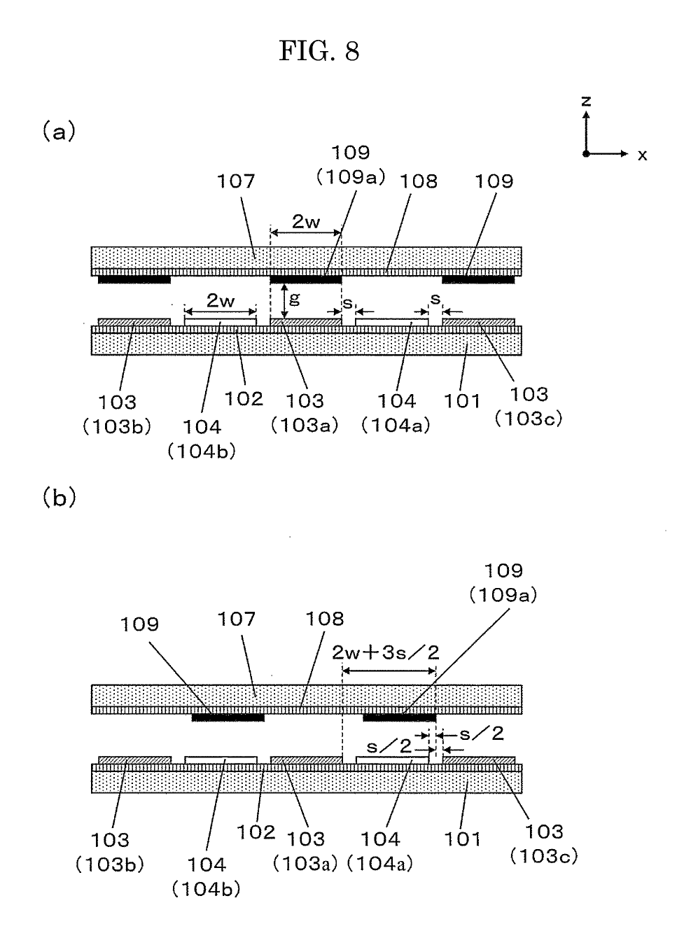

FIG. 7 is a sectional view illustrating a vibration power generator 200 according to the second exemplary embodiment of the present disclosure, FIG. 7(a) is a sectional view illustrating the state in which the vibrating body 107 is in the resting state, and FIG. 7(b) is a sectional view illustrating the state in which the vibrating body 107 is maximally displaced. FIG. 8 is a partially enlarged section of the vibration power generator 200, FIG. 8(a) is a partially enlarged section illustrating the vibration power generator 200 when the vibrating body 107 is in the resting state, and FIG. 8(b) is a partially enlarged section illustrating the state in which the vibrating body 107 is maximally displaced.

Unless otherwise noted, each element illustrated in the drawings of the second exemplary embodiment may have the same configuration as the corresponding element of first exemplary embodiment designated by the same numeral. The description of the same configuration as the first exemplary embodiment will not be given.

In the resting state of the vibrating body 107, each of the plurality of electret electrode pieces 109 disposed on the vibrating body 107 is overlapped with one first fixed electrode piece 103. For example, as illustrated in FIGS. 7(a) and 8(a), each of the plurality of electret electrode pieces 109 is overlapped only with one first fixed electrode piece 103. That is, the electret electrode piece 109 is not overlapped with the second fixed electrode piece 104 when the vibrating body 107 is in the resting state. For example, this state can be achieved by setting the width (the length in the X-direction) of the electret electrode piece 109 to the same width of 2w as the first fixed electrode piece 103 and the second fixed electrode piece 104.

In the resting state (or when the vibrating body 107 is located at the same position as the resting state even in the vibration), the capacitance generated between the electret electrode piece 109 and the first fixed electrode piece 103 becomes maximum to induce the most positive inductive charges in the first fixed electrode piece 103, and the capacitance generated between the electret electrode piece 109 and the second fixed electrode piece 104 becomes minimum to minimize the positive charge induced in the second fixed electrode piece 104.

When the vibrating body 107 vibrates and is maximally displaced, the stopper 112 regulates the electret electrode piece 109 such that the electret electrode piece 109 is overlapped with one of the two second fixed electrode pieces 104 adjacent to the first fixed electrode piece 103 on which the electret electrode piece 109 is overlapped in the resting state. The stopper 112 also regulates the maximum amplitude (maximum displacement amount) of the vibrating body 107 during the vibration of the vibrating body 107 such that the electret electrode piece 109 is not overlapped with other first fixed electrode pieces 103 except the first fixed electrode piece 103 on which the electret electrode pieces 109 is overlapped in the resting state.

For example, the stopper 112 regulates the maximum displacement of the vibrating body 107 during the vibration of the vibrating body 107 such that the electret electrode piece 109 is overlapped only with one of the two second fixed electrode pieces 104 adjacent to the first fixed electrode piece 103 with which the electret electrode piece 109 is overlapped in the resting state. For example, the stopper 112 regulates the maximum displacement of the vibrating body 107 during the vibration of the vibrating body 107 such that the electret electrode piece 109 is overlapped with the whole length in the width direction of only one of the two second fixed electrode pieces 104 adjacent to the first fixed electrode piece 103 on which the electret electrode piece 109 is overlapped in the resting state.

This will be described with reference to FIG. 8. The electret electrode piece 109a out of the plurality of electret electrode pieces 109 will be described by way of example. In the resting state, as illustrated in FIG. 8(a), the electret electrode piece 109a is overlapped with (opposed to) first fixed electrode piece 103a. The first fixed electrode piece 103a is adjacent to the second fixed electrode piece 104a and the second fixed electrode piece 104b. FIG. 8(b) illustrates the case that the vibrating body 107 is maximally displaced by the displacement of w+3s/2 (the displacement amount becomes the maximum) in the X-direction (right) in FIG. 8. The vibrating body 107 vibrates (moves) in the X-direction (right) in FIG. 8, and the displacement L of the vibrating body 107 is greater than s (s is the space between the first fixed electrode piece 103 and the second fixed electrode piece 104) (s<L). At this time, the electret electrode piece 109a is overlapped with the second fixed electrode piece 104a (and also overlapped with the first fixed electrode piece 103a in L<2w). Similarly, the vibrating body 107 vibrates (moves) in the −X-direction in FIG. 8, and the displacement L of the vibrating body 107 is less than −s (L<−s). At this time, the electret electrode piece 109a is overlapped with the second fixed electrode piece 104b (and also overlapped with the first fixed electrode piece 103a until L>−2w). Accordingly, when the maximum displacement LM is greater than s (LM>s), the electret electrode piece 109a is overlapped with one of the second fixed electrode piece 104a and the second fixed electrode piece 104b during the vibration of the vibrating body 107.

When the displacement L of the vibrating body 107 is greater than 2w (L>2w), the electret electrode piece 109a is overlapped only with the second fixed electrode piece 104a during the vibration of the vibrating body 107. Similarly, when the displacement L is less than −2w (L<−2w), the electret electrode piece 109a is overlapped only with the second fixed electrode piece 104a during the vibration of the vibrating body 107. Accordingly, when the maximum displacement LM is greater than 2w (LM>2w), the electret electrode piece 109a is overlapped only with one of the second fixed electrode piece 104a and the second fixed electrode piece 104b during the vibration of the vibrating body 107.

When the displacement L of the vibrating body 107 becomes 2w+s (L=2w+s), the electret electrode piece 109a is overlapped with the whole width of the second fixed electrode piece 104a. Similarly, when the displacement L of the vibrating body 107 becomes −(2w+s) (L=−(2w+s)), the electret electrode piece 109a is overlapped with the whole width of the second fixed electrode piece 104b. Accordingly, when the maximum displacement LM is greater than or equal to 2w+s (LM≧2w+s), the electret electrode piece 109a is overlapped with the whole length in the width direction of only one of the second fixed electrode piece 104a and the second fixed electrode piece 104b during the vibration of the vibrating body 107.

As can be seen from FIG. 8, when the displacement L of the vibrating body 107 is greater than 2w+2s (L>2w+2s), the electret electrode piece 109a is overlapped with the first fixed electrode piece 103c (that is, the first fixed electrode piece 103 on which the electret electrode piece 109a is not overlapped in the resting state). Similarly, when the displacement L of the vibrating body 107 is less than −(2w+2s) (L<−(2w+2s)), the electret electrode piece 109a is overlapped on the first fixed electrode piece 103b (that is, the first fixed electrode piece 103 on which the electret electrode piece 109a is not overlapped in the resting state). Accordingly, the maximum displacement LM is decreased less than 2w+2s (LM<2w+2s) to be able to prevent the overlapping of the electret electrode piece 109a on the first fixed electrode piece 103 (the first fixed electrode piece 103b and 103c in FIG. 8) on which the electret electrode piece 109a is not overlapped in the resting state.

For example, as illustrated in FIG. 8(b), the maximum displacement LM can be set to 2w+3s/2 (LM=2w+3s/2). When the displacement has the absolute value of 2w+s, each of the plurality of electret electrode pieces 109 is overlapped with the whole length in the width direction of one second fixed electrode piece 104 to maximize the capacitance generated between the electret electrode piece 109 and the second fixed electrode piece 104. On the other hand, the most positive inductive charges are induced in the second fixed electrode piece 104, the capacitance generated between the electret electrode piece 109 and the first fixed electrode piece 103 becomes the minimum to minimize the positive charge induced in the first fixed electrode piece 103. When the vibrating body 107 vibrates, the inductive current is excited by the increase or decrease in charge between the resting state and the maximum displacement, the voltage applied to the load 111 disposed between the first fixed electrode piece 103 and the second fixed electrode piece 104 varies, and the vibration power generator 200 generates power.

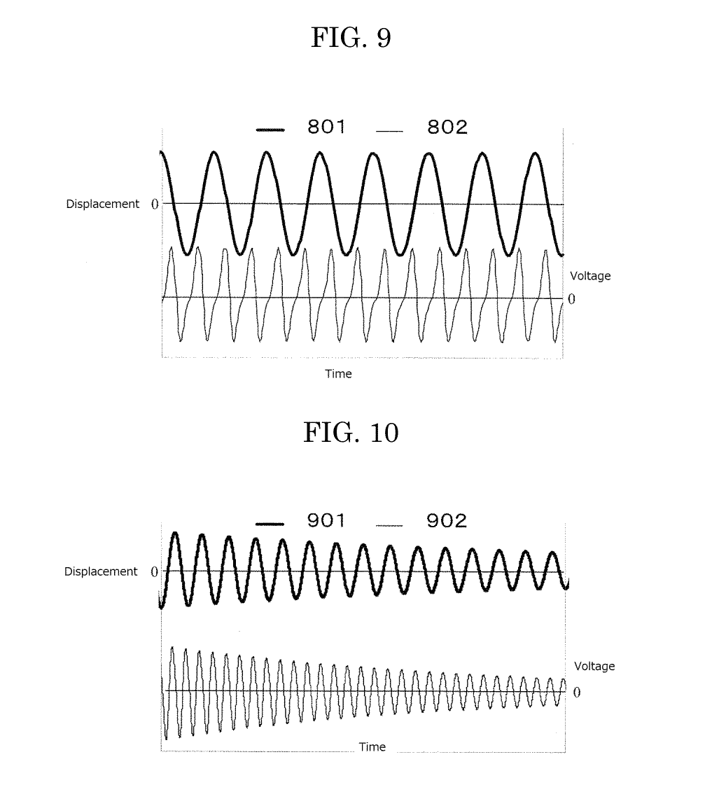

FIG. 9 is a graph illustrating a change in AC voltage 802 to a displacement 801 with respect to a sine-wave vibration of the vibrating body 107 of the vibration power generator 200 according to the second exemplary embodiment of the present disclosure. The displacement 801 of the sine-wave vibration indicates that the vibrating body 107 vibrates with the amplitude of 2w+3s/2 in the X-direction in FIG. 7 at the eigenfrequency determined by the weight of the vibrating body 107 and characteristics such as the spring constant of the spring 106. With the displacement 801 of the sine-wave vibration of the vibrating body 107, the AC voltage 802 indicates the voltage (AC voltage) generated between the first fixed electrode piece 103 and the second fixed electrode piece 104 due to the change in capacitance between the electret electrode piece 109 and the first fixed electrode piece 103 and the change in capacitance between the electret electrode piece 109 and the second fixed electrode piece 104.

As illustrated in FIG. 9, during the one cycle in which the displacement 801 of the vibrating body 107 reaches the positive maximum displacement of w+3s/2 from zero, returns to zero, reaches the negative maximum displacement of −(w+3s/2), and returns to zero, the cycle in which the AC voltage 802 reaches the positive maximum value from zero, returns to zero, reaches the negative minimum value, and returns to zero is repeated twice. That is, the vibration power generator 200 of the second exemplary embodiment generates AC power at the frequency double the vibration frequency of the vibrating body 107. Therefore, the optimum load is kept constant, and the extraction efficiency of the power generator can be enhanced by setting the load 111 corresponding to the optimum load.

As described above, even if the displacement L in which the capacitance generated between the electret electrode piece 109 and the second fixed electrode piece 104 becomes the maximum is greater than 2w+s or less than −(2w+s), because the stopper 112 regulates the vibrating body 107 such that the maximum displacement becomes (2w+3s/2), the electret electrode piece 109 is not overlapped with the first fixed electrode piece 103 on which the electret electrode piece 109 is not overlapped in the resting state. Therefore, a new wave of the AC voltage is not generated between the electret electrode piece 109 and the first fixed electrode piece 103 on which the electret electrode piece 109 is not overlapped in the resting state, but the output of the AC voltage is always obtained at the frequency double the vibration frequency of the displacement.

Even if the displacement 801 of the sine-wave vibration does not reach the maximum displacement of 2w+3s/2 regulated by the stopper 112, the cycle of the AC voltage 802 is repeated twice during the one cycle in which the displacement 801 of the vibrating body 107 reaches the positive maximum displacement from zero, returns to zero, reaches the negative maximum displacement, and returns to zero. That is, the maximum displacement of the vibrating body 107 is regulated during the vibration of the vibrating body 107 such that the electret electrode piece 109 is not overlapped with the first fixed electrode piece 103 on which the electret electrode piece 109 is not overlapped in the resting state of the vibrating body 107, whereby the AC voltage is always output at the frequency double the vibration frequency of the displacement.

As illustrated in FIG. 9, the displacement 801 and the AC voltage 802 differ from each other in the peak position (because the AC voltage 802 has the frequency double that of the displacement 801, the peak position of the displacement 801 differs from every other peak position of the AC voltage 802), and the phase difference occurs between the displacement 801 and the AC voltage 802. Sometimes the phase difference occurs between the displacement 801 and the AC voltage 802 according to the condition of the load 111 connected to the vibration power generator 200.

FIG. 10 is a graph illustrating time changes of a displacement 901 and an AC voltage 902 with respect to the free vibration when the vibrating body 107 of the vibration power generator 200 performs the free damping vibration displacement. When the large acceleration (external force) is applied to the vibrating body 107 from the outside, the vibrating body 107 is displaced to the maximum displacement regulated by the stopper 112, and then performs the free damping vibration displacement around the displacement of zero as in the displacement 901 according to the damping characteristic determined by the eigenfrequency of the vibrating body 107, the damping constant of the spring 106, and the electrostatic force between the electret electrode piece 109 and each of the first fixed electrode piece 103 and the second fixed electrode piece 104. At the maximum point of the displacement 901, the capacitance generated between the electret electrode piece 109 and the first fixed electrode piece 103 becomes minimum, and the capacitance generated between the electret electrode piece 109 and the second fixed electrode piece 104 becomes maximum. When the displacement 901 reaches zero from maximum, the capacitance generated between the electret electrode piece 109 and the first fixed electrode piece 103 becomes maximum, and the capacitance generated between the electret electrode piece 109 and the second fixed electrode piece 104 becomes minimum. When the displacement 901 reaches minimum from zero, the capacitance generated between the electret electrode piece 109 and the first fixed electrode piece 103 becomes minimum, and the capacitance generated between the electret electrode piece 109 and the second fixed electrode piece 104 becomes maximum. When the displacement 901 reaches zero from minimum, the capacitance generated between the electret electrode piece 109 and the first fixed electrode piece 103 becomes maximum, and the capacitance generated between the electret electrode piece 109 and the second fixed electrode piece 104 becomes minimum. Thus, the change in capacitance and the corresponding change in AC voltage 902 are repeated twice in the one cycle of the displacement 901. That is, in the vibration power generator 200, the electret electrode piece 109 is overlapped with (opposed to) the first fixed electrode piece 103 in the resting state. On the other hand, the vibration of the vibrating body 107 is regulated such that the electret electrode piece 109 is overlapped with the two second fixed electrode pieces 104 adjacent to the first fixed electrode piece 103 on which the electret electrode piece 109 is overlapped in the resting state, and such that the electret electrode piece 109 is not overlapped with the first fixed electrode piece 103 on which the electret electrode piece 109 is not overlapped in the resting state. In this case, even if the vibration of the vibrating body 107 does not reach the maximum displacement t, the optimum load is kept constant because the AC voltage 902 is output at the frequency double the vibration frequency of the displacement 901.

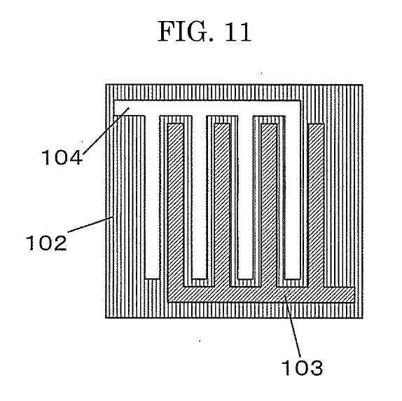

The configurations of the first fixed electrode piece 103, the second fixed electrode piece 104, the electret electrode piece 109, the vibrating body 107, the spring 106, and the spacer 105, which are used in the first and second exemplary embodiments, will be described below by way of example. FIG. 11 is a plan view illustrating a configuration example of the first fixed electrode piece 103 and the second fixed electrode piece 104. As illustrated in FIGS. 1, 2, and 5 to 8, the plurality of first fixed electrode pieces 103 and the plurality of second fixed electrode pieces 104 are alternately arrayed. The first fixed electrode pieces 103 and the second fixed electrode pieces 104 can be formed in an interdigital manner as illustrated in FIG. 11, one of two comb tooth shapes is formed by the first fixed electrode pieces 103, and the other comb tooth shape is formed by the second fixed electrode pieces 104. The plurality of first fixed electrode pieces 103 can be connected in a continuous manner, and the plurality of second fixed electrode pieces 104 can be connected in a continuous manner, which facilitates the connection to the load 111.

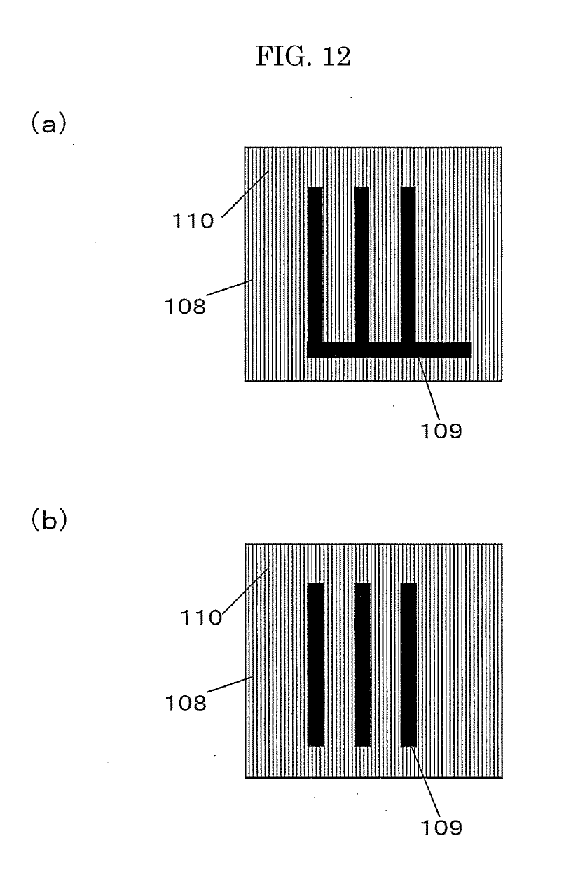

FIG. 12(a) is a plan view illustrating a configuration example of the electret electrode piece 109, and FIG. 12(b) is a plan view illustrating another configuration example of the electret electrode piece 109. As illustrated in FIG. 12(a), the plurality of electret electrode pieces 109 may be formed into a comb tooth shape by being connected in a continuous manner as in the first fixed electrode pieces 103 and second fixed electrode pieces 104 in FIG. 11, or the plurality of electret electrode pieces 109 may individually be formed into a strip shape while separated from each other as illustrated in FIG. 12(b).

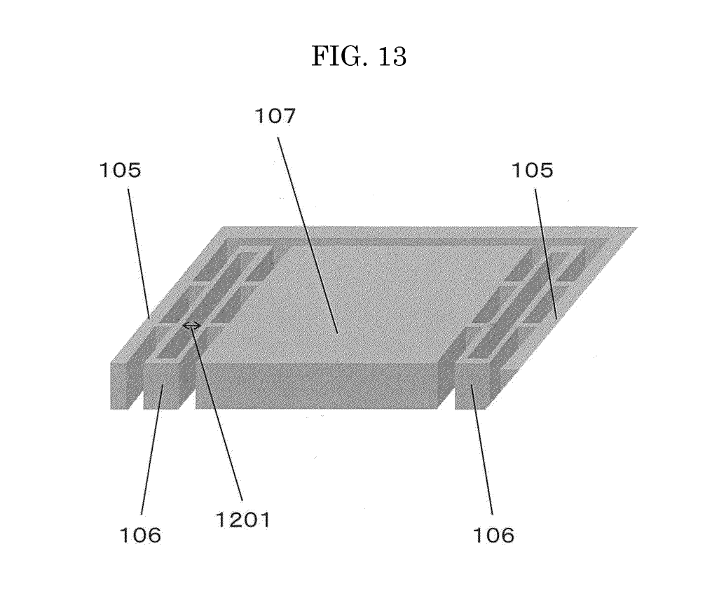

FIG. 13 is a perspective view illustrating an example in which the spacer 105, the vibrating body 107, and the spring 106 are integrally constructed. As illustrated in FIG. 13, the spacer 105, the vibrating body 107, and the spring 106 can be formed into one structure in which one substrate is etched. Therefore, toughness of the whole vibration power generator can be enhanced. Additionally, the amplitude of the vibrating body 107 can be regulated by a spring internal (air gap) 1201 provided between the springs 106. More particularly, the dimension of the spring internal (air gap) 1201 is decreased (for example, becomes zero), and the spring 106 cannot further be compressed, which allows the amplitude of the vibrating body 107 to be regulated. That is, in the configuration in FIG. 13, because the spring 106 includes the function of the stopper 112, the amplitude of the vibrating body 107 can be regulated without providing the stopper 112 that comes into contact with the vibrating body 107 to regulate the amplitude of the vibrating body 107. Thus, in the vibration power generator of the present disclosure, as long as the amplitude of the vibrating body 107 can be regulated within the desired range, it is not necessary to separately provide the stopper 112.

The present disclosure can be applied to the vibration power generator that converts the vibration energy into the electric power.

What is claimed is:

1. A vibration power generator comprising:
a fixed substrate;
a first fixed electrode piece that is disposed on the fixed substrate, the first fixed electrode piece having a first width of 2w;
a second fixed electrode piece that is disposed on the fixed substrate with a space s from the first fixed electrode piece, the second fixed electrode piece having a second width of 2w;
a cover substrate that is disposed with a space g from the fixed substrate, the cover substrate being opposed to the fixed substrate;
a vibrating body that is disposed between the fixed substrate and the cover substrate in a vibratable state; and
an electret electrode piece that is disposed on the vibrating body, the electret electrode piece being opposed to the first fixed electrode piece and the second fixed electrode piece, the electret electrode piece having a width that is greater than 2w and less than or equal to 2w+s,
wherein the electret electrode piece is opposed to both the first fixed electrode piece and the second fixed electrode piece, and overlaps with both the first fixed electrode piece and the second fixed electrode piece, when the vibrating body is in a resting state.

2. The vibration power generator according to claim 1, wherein the width of the electret electrode piece is located at a position opposed to the whole width of one of the first fixed electrode piece and the second fixed electrode piece, when the vibrating body is maximally displaced.

3. The vibration power generator according to claim 1, wherein an insulating layer is interposed between the fixed substrate and each of the first fixed electrode piece and the second fixed electrode piece.

4. The vibration power generator according to claim 1, wherein the vibrating body is disposed between the fixed substrate and the cover substrate in a vibratable state using a vibrating spring.

5. The vibration power generator according to claim 1, comprising: a plurality of the first fixed electrode pieces, and a plurality of the second fixed electrode pieces,
wherein a plurality of the first fixed electrode pieces and a plurality of the second fixed electrode pieces are alternately disposed on the fixed substrate.

6. The vibration power generator according to claim 1, wherein a stopper that regulates an amplitude of the vibrating body is disposed between the fixed substrate and the cover substrate.

7. A vibration power generator comprising:
a fixed substrate;
a first fixed electrode piece that is disposed on the fixed substrate, the first fixed electrode piece having a first width of 2w;
a second fixed electrode piece that is disposed on the fixed substrate with a space s from the first fixed electrode piece, the second fixed electrode piece having a second width of 2w;
a cover substrate that is disposed with a space g from the fixed substrate, the cover substrate being opposed to the fixed substrate;
a vibrating body that is disposed between the fixed substrate and the cover substrate in a vibratable state; and
an electret electrode piece that is disposed on the vibrating body, the electret electrode piece being opposed to the first fixed electrode piece and the second fixed electrode piece, the electret electrode piece having a width that is greater than or equal to 2w,
wherein the electret electrode piece is opposed to the whole width of one of the first fixed electrode piece and the second fixed electrode piece, when the vibrating body is in a resting state.

8. The vibration power generator according to claim 7, wherein, when the vibrating body is maximally displaced, the electret electrode piece is located at a position opposed to one of the first fixed electrode piece and the second fixed electrode piece after passing by one of the first fixed electrode piece and the second fixed electrode piece from the other of the first fixed electrode piece and the second fixed electrode piece.

9. The vibration power generator according to claim 7, wherein an insulating layer is interposed between the fixed substrate and each of the first fixed electrode piece and the second fixed electrode piece.

10. The vibration power generator according to claim 7, wherein the vibrating body is disposed between the fixed substrate and the cover substrate in a vibratable state using a vibrating spring.

11. The vibration power generator according to claim 7, comprising:
the plurality of first fixed electrode pieces; and
the plurality of second fixed electrode pieces,
wherein the plurality of first fixed electrode pieces and the plurality of second fixed electrode pieces are alternately disposed on the fixed substrate.

12. The vibration power generator according to claim 7, wherein a stopper that regulates an amplitude of the vibrating body is provided between the fixed substrate and the cover substrate.
